(19) United States
(12) Patent Application Publication
(10) Pub. No.: US 2026/0170540 A1
(43) Pub. Date: Jun. 18, 2026

(54) PACKAGING IDENTIFICATION FOR AGE-RESTRICTED ITEMS

(71) Applicant: TOSHIBA GLOBAL COMMERCE SOLUTIONS, INC., Durham, NC (US)

(72) Inventors: Yeshai BOUSKILA, Plano, TX (US); Andrei KHAITAS, McKinney, TX (US); Evgeny SHEVTSOV, Plano, TX (US)

(21) Appl. No.: 18/981,107

(22) Filed: Dec. 13, 2024

(51) Int. Cl. G06Q 30/0601; G06Q 20/18; G06Q 20/20; G06V 10/75; G06V 10/764; G06V 10/82; G06V 20/52; G06V 20/62

(52) U.S. Cl. CPC G06Q 30/0607; G06Q 20/18; G06Q 20/201; G06Q 20/208; G06V 10/751; G06V 10/764; G06V 10/82; G06V 20/52; G06V 20/62

(57) ABSTRACT

The present disclosure provides methods and apparatus for identifying packaging for age-restricted products at self-checkout devices. A self-checkout device receives a barcode of an item, and compares the barcode with a database that comprises barcode data associated with one or more age-restricted products. The self-checkout device then captures an image of the item using a camera, and performs image comparison by providing the captured image to a trained machine learning model as an input. In response to at least one of the barcode comparison or the image comparison indicating a match with an age-restricted product, the self-checkout device triggers a manual verification for the item

### BACKGROUND

In a typical self-checkout transaction, the customer scans the barcode of each item and places it on a scale to verify the product's weight. The self-checkout device then cross-references the barcode with a database to retrieve the item's name and price, and displays this information on the screen for customer review. For general merchandise, this process is sufficient for accurate pricing and verification. However, for restricted products (e.g., products subject to age restrictions), this workflow may not adequately prevent disallowed purchase.

### BRIEF DESCRIPTION OF THE DRAWINGS

FIG. 1 depicts an example self-checkout device with packaging identification functions for age-restricted products, according to some embodiments of the present discourse.

FIG. 2 depicts an example workflow for identifying age-restricted products using convolutional neural networks (CNNs), according to some embodiments of the present discourse.

FIG. 3 depicts an example workflow for identifying age-restricted products using text recognition and database comparison, according to some embodiments of the present discourse.

FIGS. 4A and 4B depict an example method for verifying age-restricted products using visual and textual analysis, according to some embodiments of the present discourse.

FIG. 5 is a flow diagram illustrating an example method for age-restricted product verification, according to some embodiments of the present disclosure.

FIG. 6 depicts an example computing device configured to perform various aspects of the present disclosure, according to some embodiments of the present disclosure.

### DETAILED DESCRIPTION

The present disclosure relates to self-checkout systems and, more specifically, to identifying and verifying age-restricted products based on packaging features.

Self-checkout systems offer a streamlined and convenient shopping experience, allowing customers to independently scan items, place the items on scales, and complete payments. However, when handling restricted products (e.g., age restricted products, such as alcohol, tobacco, or certain medications), self-checkout systems meet additional challenges in accurately identifying products and verifying that any relevant restrictions are satisfied. The current process typically relies on a barcode to identify items requiring age verification, which prompts the system to request an intervention from store personnel to validate the buyer's age. However, relying solely on barcode identification may sometimes lead to product misinterpretation, potentially due to barcode damage, misplacement, or even similar barcode sequences on non-age-restricted items. These scenarios introduce the risk of incorrectly flagging or missing age-restricted items, which might lead to unauthorized purchases.

The present disclosure introduces methods, systems, and apparatuses that enhance the verification of restricted products in self-checkout transactions. In some embodiments, the disclosed system provides improved accuracy by incorporating visual analysis into the verification process, analyzing unique features of product packaging to detect age-restricted products. Unlike existing systems that rely solely on barcode scanning, the disclosed system utilizes image capture and machine learning algorithms, such as convolutional neural networks (CNNs), to analyze packaging characteristics, including shape, size, texture, color patterns, and textual information. The disclosed multi-layer verification approach addresses the abovementioned limitations and other concerns in conventional barcode-scanning system. This approach enables the identification of age-restricted products even when barcodes are damaged, missing, or misplaced. By performing visual analysis, the system may cross-verify packaging features against predefined models, effectively preventing (or at least reducing) underage purchases while maintaining a smooth and frictionless customer experience. Furthermore, the system's ability to dynamically incorporate text recognition adds another layer of verification, allowing the detection of age-restricted products based on brand names or descriptive terms printed on packaging.

The disclosed identification and verification process improves compliance with age-restriction regulations, effectively preventing unauthorized purchases, while minimizing (at least reducing) interruptions to the customer's self-checkout experience.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to the described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the described embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.”

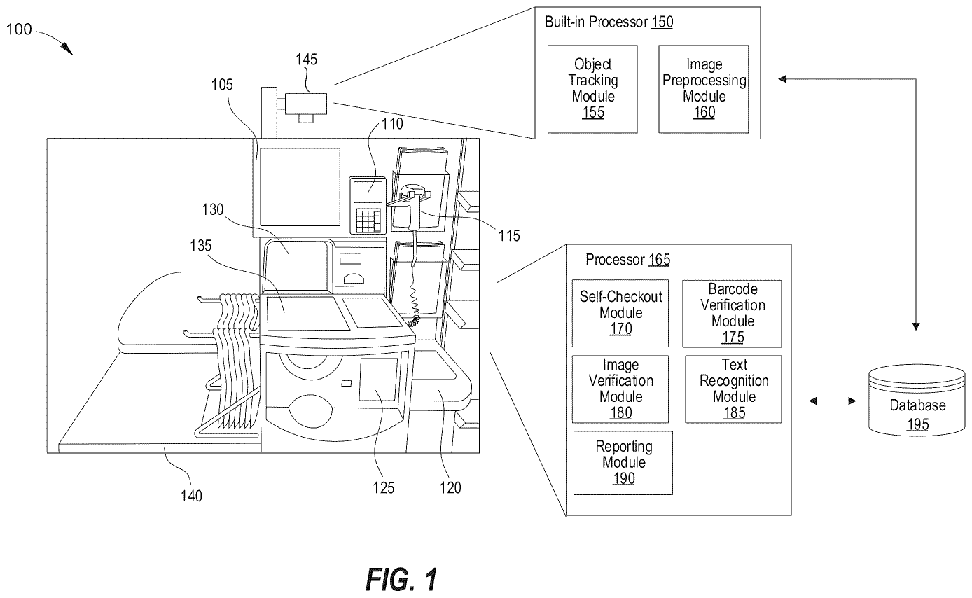

FIG. 1 depicts an example self-checkout device 100 with packaging identification functions for age-restricted products, according to some embodiments of the present discourse.

As illustrated, the example self-checkout device 100 includes various components that work together to facilitate efficient self-checkout transaction processing. These components include a loading area 120, a bagging area 140, a display screen 105, a built-in scanner 130, a handheld scanner 115, a scale 135, a payment terminal 110, a receipt printer 125, and a camera 145 with a built-in processor 150.

The loading area 120 is designed to hold a customer's shopping cart or basket before items are scanned. The bagging area 140 is used to place items after they have been scanned. The display screen 105 serves as the primary interface for customers. In some embodiments, the screen 105 may show a shopping list that includes all scanned items, each item's quantity and price, and a total price of all items. When an age-restricted product is identified (e.g., alcohol, tobacco, medicines), the screen 105 may display a notification informing the customer that assistance from a store associate is required to verify his or her age before proceeding with the purchase.

The built-in scanner 130 and handheld scanner 115 are used to read one-dimensional (1D) or two-dimensional (2D) barcodes on products. Once scanned, the product's name and price are displayed on the screen 105 within the shopping list. The scale 135 is used to weigh items to determine their price. The payment terminal 110 is designed for processing payments, completing the transaction once all items are scanned and verified. The terminal may support various payment methods, including card and mobile payment. The receipt printer 125 automatically prints a transaction receipt for customers after the payment is complete. In some embodiments, the receipt may summarize the purchase and indicates any items requiring age verification.

As depicted, the camera 145 is mounted above or near the scanning area, capturing images of each item as it is scanned. In some embodiments, the camera 145 may be top-mounted or side mounted, oriented toward the scanning area. In some embodiments, the camera may be integrated within the scanner 130 itself. As depicted, the camera 145 includes a built-in processor 150 configured to manage initial image processing tasks before passing the images to the main processor 165 of the self-checkout device for further verification. As depicted, the built-in processor 150 includes two software modules (or programming instructions): the object tracking module 155 and the image preprocessing module 160. The object tracking module 155 is configured to detect when an item enters the camera's field of view, track the item's position, and capture images at appropriate moments (e.g., when the item is fully within the frame). The image preprocessing module 160 is programmed to perform image enhancements, such as brightness and contrast adjustment, noise reduction, cropping and resizing, and the like. The preprocessing operation prepares that image to meet the quality standards useful for accurate verification. After the image is captured and preprocessed, the camera 145 transmits the image to the main processor 165, where visual verification is performed by analyzing the item's packaging features to identify age-restricted products.

In some embodiments, the camera 145 may be connected to the main processor 165 through either a wired connection (e.g., an Ethernet or USB cable), or wirelessly (e.g., via Wi-Fi, Bluetooth, or other wireless protocols).

In some embodiments, the camera 145 may not have a built-in processor 150. In such configuration, the camera 145 may capture images of an item as it is scanned and directly transmit the captured images to the main processor 165 for analysis.

As depicted, the self-checkout device 100 further includes a main processor 165, which serves as the central processing unit of the device, managing the entire transaction process and performing age-restricted product verification when applicable. As shown, the main processor 165 is connected to a database 195 via either a wired connection (e.g., Ethernet or USB cable) or a wireless link (e.g., Wi-Fi or Bluetooth). In some embodiments, the database 195 may contain information relevant to the self-checkout process, including unique product identifiers (e.g., barcodes or stock keeping unit (SKU) numbers), detailed product information (including name, description, and category), and current pricing information. The data supports the self-checkout device to accurately display scanned items and calculate the total price. The database 195 may also include data used for verifying age-restricted products. This may include age-restriction indicators (which are linked to product identifiers and specify legal age requirements), product packaging features (e.g., size, color patterns, shape) associated with age-restricted items, and brand names and/or keywords commonly linked to age-restricted items. In some embodiments, the data required for age-restricted product verification may be stored across multiple different databases. These databases may be connected via a network infrastructure (e.g., local area network (LAN) or cloud-based server), allowing the self-checkout device to access and cross-reference data from each source as needed.

As depicted, the main processor 165 includes five software modules (or programming instructions): the self-checkout module 170, the barcode verification module 175, the image verification module 180, the text recognition module 185, and the reporting module 190.

The self-checkout module 170 manages the overall self-checkout process, including item scanning and weighting (e.g., using the built-in scanner 130 or the handheld scanner 115 and the scale 135), price calculation and transaction display (e.g., via the monitor 105), payment processing (e.g., via the payment terminal 110), and transaction finalization (e.g., by printing a receipt using the receipt printer 125).

The barcode verification module 175 receives barcode data captured by either the built-in barcode scanner 130 or handheld scanner 115, or SKU numbers manually entered through the screen 105. The barcode verification module 175 checks database 195 to determine if the item is age-restricted. If the barcode or SKU number is linked to an age-restriction indicator, indicating that the corresponding item is age-restricted, the module 175 pauses the transaction and triggers manual verification.

The image verification module 180 uses trained machine learning (ML) models to analyze captured images (e.g., by the camera 145) and determine whether the item is age-restricted. The ML model may include CNNs trained on historical datasets to learn visual features (e.g., size, shape, and color patterns) associated with age-restricted product packaging. Once trained, the model is deployed to analyze new captured images and output a classification indicating whether the item is age-restricted. The image verification module 180 can identify age-restricted items even if barcode data is missing, damaged, or inconclusive. The image verification module 180 improves the self-checkout device's accuracy in identifying age-restricted products, compared with prior systems that rely on barcode scanning, which can fail when barcodes are obscured, misaligned, or corrupted. By analyzing visual features directly from the packaging, the module 180 reduces the likelihood of false positive (e.g., flagging non-age-restricted items) and false negatives (e.g., missing age-restricted items). Furthermore, the integration of ML models allows the system to adapt and generalize to a wide variety of packaging designs and product categories, improving its accuracy and robustness across different retail environments.

The text recognition module 185 applies optical character recognition (OCR) techniques to the captured images, and extracts text printed on the item's packaging. The module 185 then compares the extracted text (e.g., brand names or other relevant keywords) with the database entries for known age-restricted products. The additional verification layer allows the device to identify age-restricted items accurately even when other visual features, such as size, shape, or color patterns, are ambiguous or insufficient. The text-based verification addresses limitations of prior systems that rely on barcode scanning. With the text recognition module 185, the self-checkout device 100 may detect age-restricted products based on specific terms, such as “6 pack” or brand names commonly associated with alcohol or tobacco. The text-based analysis provides a fallback mechanism when other methods fail.

The reporting module 190 updates the database 195 in real time with transaction details, including the item purchased, total cost, and any verification actions performed and corresponding results. The data may then be used to further refine the verification process for improved accuracy over time. The reporting module 190 further sends alerts to store associates if manual verification is required and displays notifications on the self-checkout screen 105.

The self-checkout module 170, the barcode verification module 175, the image verification module 180, the text recognition module 185, and the reporting module 190 are depicted as discrete components (or programming instructions) in FIG. 1 for conceptual clarity. In some embodiments, the operations of the depicted modules (and others not illustrated) may be combined or distributed across any number of computing devices.

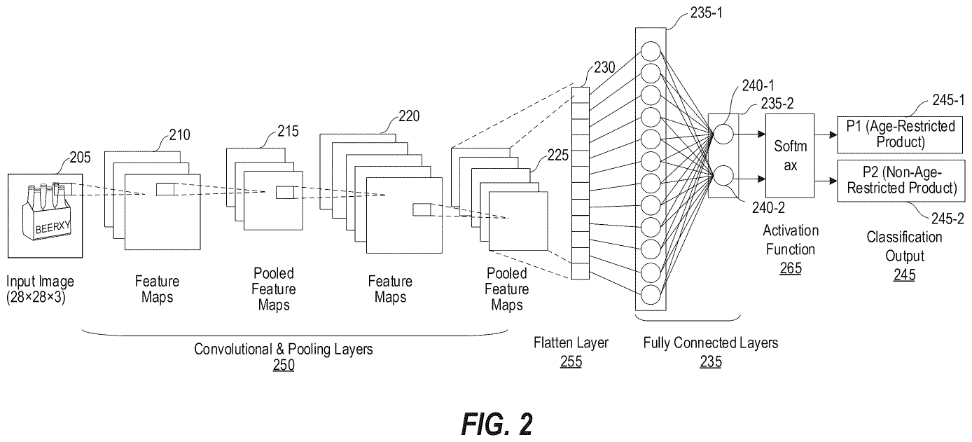

FIG. 2 depicts an example workflow 200 for identifying age-restricted products using CNNs, according to some embodiments of the present discourse. The example workflow 200 may be managed by the image verification module 180 as depicted in FIG. 1, and may be executed either by a single computing device or system (e.g., the main processor 165 of FIG. 1) or across a collection of distributed computing devices or systems.

As depicted, the CNN include multiple convolutional and pooling layers 250 to perform feature extraction, followed by one or more fully connected layers 235 for classification. The convolutional and pooling layers process the input image 205 to extract visual features, such as sizes, shapes, and colors, from the input image 205, while the fully connected layers 235 integrate these features to determine whether the item is age-restricted or non-age-restricted.

In the depicted example workflow 200, the input image 205 capturing details of a scanned item first pass through a sequence of convolutional and pooling layers 250 to extract relevant visual features. In this process, the image 205 moves through a first convolutional layer, where filters (or kernels) are applied to detect relevant low-level features (e.g., edges or textures) that characterize the item's packaging. This convolutional operation produces a set of feature maps 210 that represent the detected patterns across the image. In some embodiments, following the convolution, a rectified liner unit (ReLU) activation function may be applied to introduce non-linearity into the extracted features. Following that, the feature maps 210 generated by the first convolutional layer are passed through a first pooling layer. Using max pooling, the dimensionality of the feature maps 210 is reduced by retaining only the most prominent values within each region. Through the first pooling layer, a set of pooled feature maps 215 is generated.

As depicted, a second convolutional layer is then applied to these pooled feature maps 215, using similar filters (or kernels) to detect more complex (or high-level) visual features associated with the item's packaging (e.g., shapes or color schemes). In some embodiments, a ReLU activation function may be applied to introduce non-linearity. Following that, the feature maps 220 from the second convolutional layer are fed into a second pooling layer, which performs another max pooling operation to create a second set of pooled feature maps 225. This additional pooling further condenses the visual information, preserving the most relevant values identified by the second convolutional layer. The depicted use of two convolutional layers and two pooling layers is provided for conceptual clarity. In some embodiments, any number of convolutional and pooling layers (including one) may be applied depending on the complexity of the model and the level of feature extraction required.

After passing through these convolutional and pooling layers 250, the resulting pooled feature maps 225 are then flattened into a single vector in the flatten layer 255 and processed by the one or more fully connected layers 235. As depicted, the first fully connected layer 235-1 (also referred to in some embodiments as the input layer) receives the flattened vector 230 and processes it, and from there, the data passes through one or more hidden layers (not shown), and ultimately reaches the output layer 235-2. Each fully connected layer includes numerous neurons that apply weights and biases to the input values. These fully connected layers progressively refine the features extracted from the image to form connections between patterns that are relevant to classifying age-restricted items.

As depicted, the output layer 235-2 includes two neurons, each corresponding to a specific classification: the neuron 240-1 represents the probability that the item is age-restricted, and the neuron 240-2 represents the probability that the item is not age-restricted. Each neuron in the output layer 235-1 performs a weighted sum of the inputs, adds a bias term, and then provides the result to an activation function 265 (e.g., softmax function). The activation function 265 normalizes these outputs into probabilities, representing the confidence in each classification as a value between 0 and 1. As depicted, two probabilities are generated: the probability 245-1 (e.g., P₁ (age-restricted)) represents the likelihood that the item is age-restricted, and the probability 245-2 (e.g., P₂ (non-age-restricted)) represents the likelihood that the item is not age-restricted.

In some embodiments, the network may be configured to classify the item into multiple categories rather than a simple age-restricted or non-age-restricted distinction. For example, the output layer 235-2 may include multiple neurons 240, each corresponding to a specific category (e.g., beer, wine, spirits, tobacco, or non-age-restricted). The activation function 265 may then normalize these outputs into probabilities for each category, such as the probability that the item is beer (P₁(beer)), the probability that the item is wine (P₂(wine)), the probability that the item is spirits (P₃(spirits)), the probability that the item is tobacco (P₄(tobacco))or the probability that the item is not age-restricted product (P₅(non-age-restricted)). These probabilities sum to 1, through which the system may interpret the networks' confidence for each potential classification.

In some embodiments, to produce a final classification that indicates whether the scanned item is age-restricted, a filter may be applied based on these probabilities 245, and the category with the highest probability may be selected as the final classification. For binary classification, if P₁ (age-restricted) 245-1 is greater than P₂ (non-age-restricted), the network outputs “1”, indicating that the item is likely age-restricted. If P ₂ (non-age-restricted) 245-2 is higher, the network outputs “0”, indicating that the item is not age-restricted. In some embodiments, a threshold may be applied to maintain higher confidence in the classification. For example, the network may require a probability above 0.7 for any age-restricted category before confirming the results. If P₁ (age-restricted) 245-2 is greater than the threshold, the network classifies the item as age-restricted and triggers manual verification. Otherwise, the transaction continues without interruption.

In some embodiments, the CNNs may be trained on historical data that include a large amount of labeled samples (e.g., images) of both age-restricted and non-age-restricted products. Each training sample in the dataset may include an input image, which captures a product's packaging, and a corresponding label, which indicates the correct product classification, such as whether the item is age-restricted or non-age-restricted, or identifying the specific categories of the items (e.g., beer, wine, spirits). During training, the CNNs may process each input image through the layers, extracting visual features and generating an initial prediction based on the model's current state. This prediction may then be compared to the label to calculate an error or loss, which represents the difference between the prediction and the correct classification. To minimize (or at least reduce) the error and improve accuracy, the CNNs may perform backpropagation, where the error or loss is propagated backward through the network, from the output layer 235-2 to the input layer 235-1, to calculate gradients for each weight and bias in the network. These gradients indicate the direction and magnitude of adjustments needed for each parameter to reduce the error. The CNNs may use optimization algorithms (e.g., stochastic gradient descent) to adjust the weights and biases based on the gradients. The fine-turning process may be repeated over several training epochs until the loss or error falls under a defined threshold. As the model's weights and biases are adjusted, the model becomes more accurate in identifying age-restricted products. Once the training is complete, the model may be deployed to process new and unseen images and generate predictions in real time.

The softmax activation function 265 is depicted for conceptual clarity. In some embodiments, other activation functions may be applied within the network, such as sigmoid, tanh, or ReLU, and more. These functions may be selected based on the specific requirements of the model architecture to optimize feature learning and classification accuracy.

In some embodiments, the self-checkout system may utilize the trained model (e.g., CNNs) for image verification, as depicted in the example workflow 200, after an initial barcode verification has been performed. For example, if the barcode verification indicates that the product is not age-restricted, or if the barcode is invalid, ambiguous or unrecognizable, the system may conduct additional security checks by initiating the image verification. This selective approach to image verification optimizes (or at least improves) the usage of system recourses by only processing images when necessary. Instead of verifying every item visually, the system selectively captures and analyzes images of items with ambiguous or insufficient barcode data. The selective approach reduces the overall computation burden and minimizes (or at least reduces) processing delays.

In some embodiments, the system may operate barcode and image verification in parallel, with each process independently assessing the scanned item for age-restriction status. If either the barcode or the image verification flags the item as age-restricted, manual verification is triggered to confirm the buyer's eligibility for the restricted item. Conversely, if both verification methods conclude that the item is not age-restricted, the transaction proceeds without interruption.

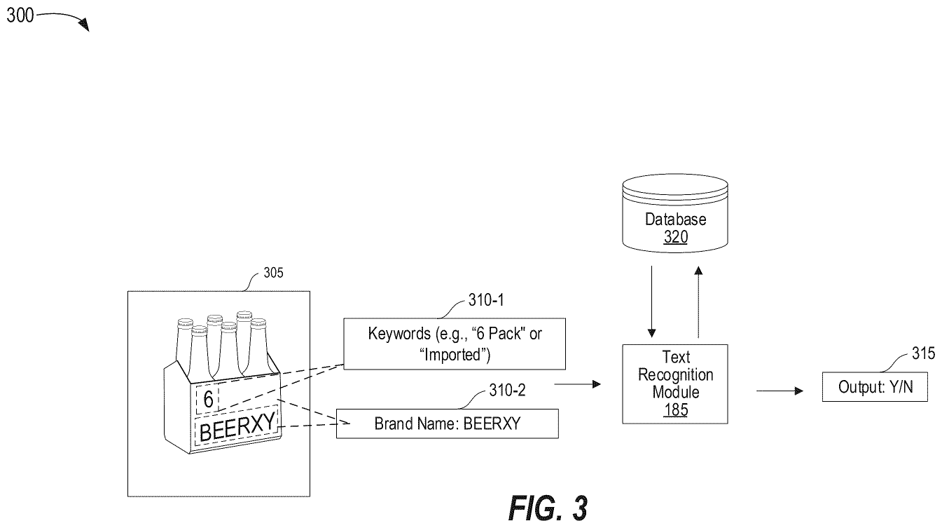

FIG. 3 depicts an example workflow 300 for identifying age-restricted products using text recognition and database comparison, according to some embodiments of the present discourse. The example workflow 300 may be managed by the text recognition module 185 as depicted in FIG. 1, and may be executed either by a single computing device or system (e.g., the main processor 165 of FIG. 1) or across a collection of distributed computing devices or systems.

As depicted, the image 305 capturing a scanned item is provided to the text recognition module 185, which uses OCR techniques to identify text printed on the item's packaging. Examples of extracted text may include specific brand name 310-2 (e.g., “BEERXY”) or other keywords 310-1 that may be associated with age-restricted products (e.g., “6 Pack” or “Imported”). Once these keywords are extracted, the text recognition module 185 searches through a database 320 to compare these keywords 310 with a predefined list of terms and phrases linked to age-restricted products. The list of terms and phrases may include known age-restricted brands, packaging descriptors, and relevant keywords that aid in classification. Based on the comparison, the module 185 generates an output 315, which indicates whether the item is age-restricted.

In some embodiments, the database 320 may correspond to the database 195 as depicted in FIG. 1, which includes relevant data for barcode verification, visual verification, and text recognition. In some embodiments, the database 320 may be separate, specifically configured to store keywords, brand names, and packaging descriptors relevant to age-restricted products.

The depicted workflow 300 for text recognition and data comparison adds another layer of accuracy in identifying age-restricted items, particularly when visual or barcode data is ambiguous or insufficient. In some embodiments, the text recognition process may be performed in parallel with the barcode or visual verification, analyzing the scanned item and relevant captured images independently. If any of these methods indicate that the item is age-restricted, the system triggers a manual verification prompt, alerting store associates to confirm the buyer's eligibility. In contrast, if all verification methods pass without flagging age restrictions, the self-checkout transaction proceeds without interruptions. In some embodiments, the text recognition process may be performed after visual or barcode verification has been completed. In the sequential setup, the text recognition may be activated if barcode or visual verification is inconclusive or fails to classify the item. This selective or dynamic use of text recognition helps to reduce computational burden compared to a layered-on evaluation approach, where all verification methods run for every item.

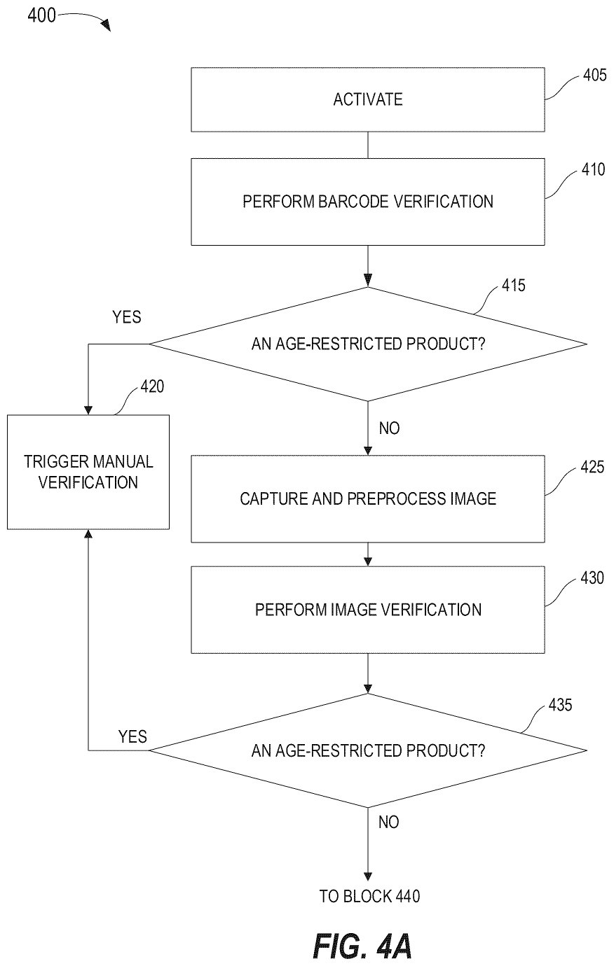

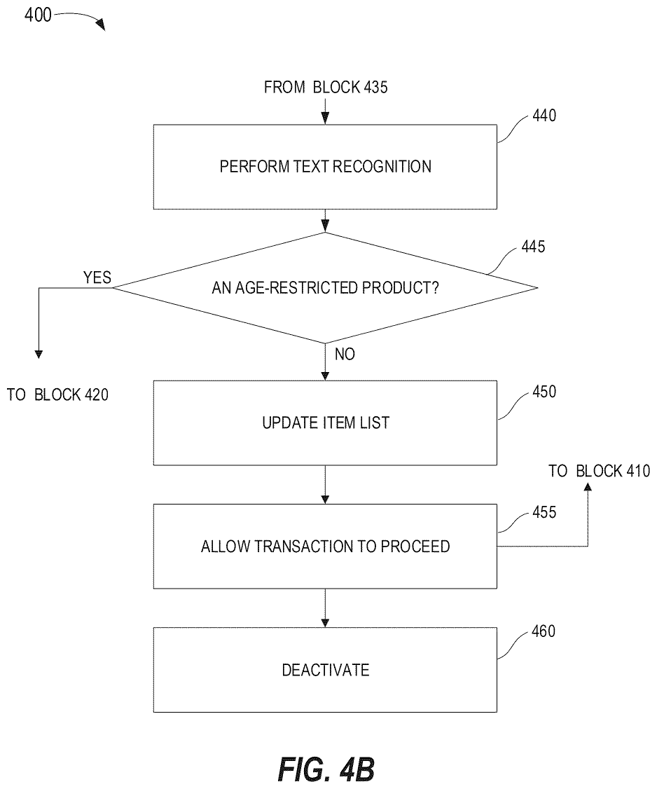

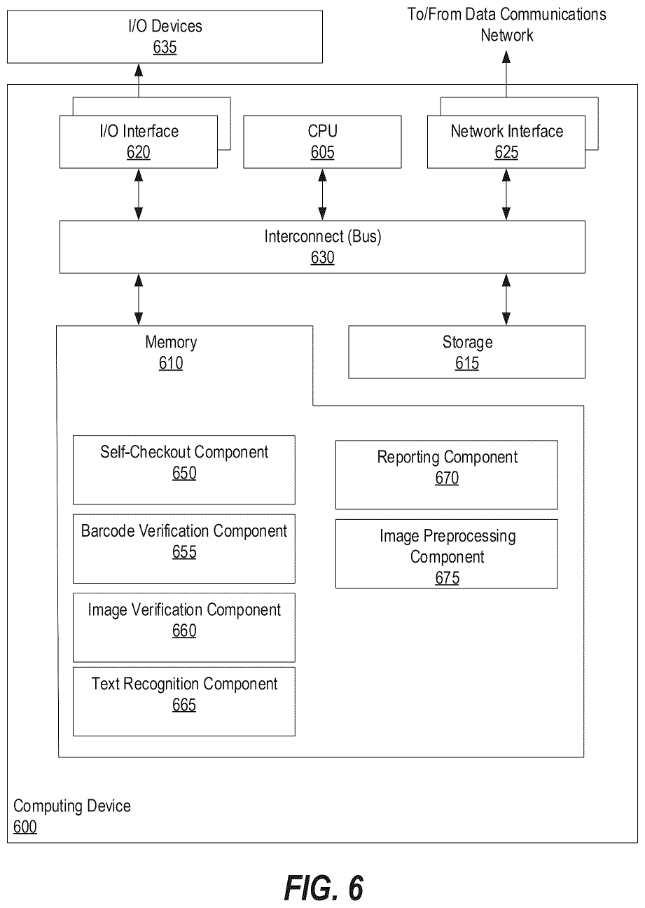

FIGS. 4A and 4B depict an example method 400 for verifying age-restricted products using visual and textual analysis, according to some embodiments of the present discourse. In some embodiments, the method 400 may be performed by one or more computing devices or systems, such as the self-checkout device 100 as depicted in FIG. 1, or the computing device 600 as depicted in FIG. 6.

At block 405, a self-checkout system or device is activated by a customer to start a new self-checkout transaction. The activation may involve the customer interacting with the system by tapping its screen (e.g., 105 of FIG. 1), scanning an item, or clicking a “Start Checkout” button.

At block 410, the self-checkout system (e.g., via the barcode verification module 175 of FIG. 1) reads the barcode of an item via either a built-in scanner (e.g., 130 of FIG. 1) or handheld scanner (e.g., 115 of FIG. 1). The system then compares the scanned barcode with entries in a connected database (e.g., 195 of FIG. 1). The database contains detailed information for each item, including product identifier (e.g., the unique barcode or SKU number), the item's name, brand, price, and category (e.g., beverage, snacks), age-restriction indicators (e.g., suggesting whether the item is age-restricted) and linked legal requirements, and other relevant data. The system performs a lookup by matching the scanned barcode against the product identifiers in the database. If a direct match is found, the system retrieves the associated product information, including the item's name, price, and any age-restricted indicator if available.

At block 415, the self-checkout system determines whether the scanned item is age-restricted. If a match is found and the retrieved product information includes an age-restriction indicator, the system identifies the item as age-restricted. The method 400 then proceeds to block 420, where the system triggers manual verification. To initiate the manual verification, in some embodiments, the self-checkout system may display a notification instructing the customer to seek assistance, and the store associate may then check the customer's identity card and verify his or her eligibility for the restricted product. In some embodiments, a message may be automatically sent to a stationary and/or handhold device of a store associate, informing the associate that age verification is needed at a specific checkout device.

If a barcode match is found and the retrieved product information does not include an age-restriction indicator, the system classifies the item as non-age-restricted for the barcode verification. In embodiments where the system is configured to rely exclusively on barcode verification, with no further verification mechanisms implemented, the method 500 may proceed to block 445 (in FIG. 4B), where the system updates the item list and allows the transaction to continue without further checks. In embodiments where visual (or image) verification is implemented, the method 500 proceeds to block 425, where the system captures and processes an image for further analysis.

If a barcode match is not located in the database (e.g., indicating that the database lacks sufficient information for this item) or if the barcode is unrecognizable (e.g., possible due to damage or misalignment), the method 500 may proceed to block 425, where additional visual verification is performed to determine the item's age-restriction status despite limitations in the barcode data.

At block 425, the system captures images of the item using a camera (e.g., 145 of FIG. 1) mounted near or above the self-checkout scanning area. The images may provide visual data of the item, such as packaging details that indicate whether the item is age-restricted. In some embodiments, the camera may be configured with a built-in processor (e.g., 150 of FIG. 1), which tracks the item's position within the scanning area, and performs auto-focus and/or exposure control to optimize image clarity based on ambient lighting conditions. After capturing the images, the system applies a sequence of preprocessing operations to improve image quality for further analysis. The preprocessing operations may include, but are not limited to, brightness and contrast adjustment, noise reduction, cropping and resizing, color normalization, and edge detection and sharpening. In some embodiments, the preprocessing operations may be performed by the built-in processor within the camera (e.g., via the image preprocessing module 160 of FIG. 1).

At block 430, the system uses one or more trained ML models (e.g., CNNs) to analyze the preprocessed images and determine whether the captured item is age-restricted. The visual (or image) verification process may include extracting relevant features from the images, such as shape, texture, size, and color patterns that are associated with age-restricted packaging. After feature extraction, the CNN model may pass these feature maps through one or more fully connected layers (e.g., 235 of FIG. 2), which integrate the features by assigning weights and biases and ultimately form a comprehensive representation of the item's visual characteristics. The output layer of the CNN model may then apply an activation function (e.g., softmax function) (e.g., 265 of FIG. 2) to output probabilities for each classification, with one probability indicating the likelihood that the item is age-restricted (e.g., P₁ (age-restricted) 245-1 of FIG. 2), and the other one for non-age-restricted (e.g., P₂ (non-age-restricted) 245-2 of FIG. 2).

At block 435, the system determines whether the visual (or image) verification process suggests the item is age-restricted. In some embodiments, the decision may be developed based on the probabilities output by the CNN model, such as if the model's output indicates a high probability that the item is age-restricted (e.g., P₁ (age-restricted) 245-1 of FIG. 2) (e.g., exceeding a predefined threshold), the system may flag the item as age-restricted. In this configuration, the method 500 moves to block 420, where manual verification is triggered. Otherwise, the system may classify the item as non-age-restricted. In embodiments where no further verification methods are implemented, the method 400 proceeds to block 455 (in FIG. 4B), where the item list is updated and the self-checkout transaction continues without interruption. In embodiments where text recognition is implemented as an additional verification layer, the method 400 moves to block 440 in FIG. 4B).

If the visual data is insufficient to produce a reliable result (e.g. possible due to poor image quality, or lack of distinctive features) and the text recognition is implemented, the method 400 also moves to block 440 (in FIG. 4B) to ensure accurate classification.

At block 440 (in FIG. 4B), the system analyzes the captured images and applies text recognition techniques (e.g., OCR) to extract visible text from the item's packaging. Examples of extract text may include brand names (e.g., “BEERXY”) and descriptors that are typically associated with age-restricted items (e.g., “6 Pack” or “Imported”). Once extracted, these keywords are then compared against entries saved in a database. The database includes known brand names, packaging descriptors, and other relevant keywords.

At block 445, the system determines whether the item captured in the images is age-restricted by comparing the extracted keywords or phrases against entries saved in a database. If a match is found between the extracted text and the database entries, indicating that the item likely falls under age-restriction requirements, the method 400 moves to block 420 (in FIG. 4A), triggering manual age verification. If no match is identified, the system concludes that the item is likely not age-restricted. The method 400 moves to block 450, where the item is added to the transaction list. At block 455, the self-checkout transaction continues to the next product. The system loops back to block 410 (in FIG. 4A) to receive the barcode of the next product.

At block 460, the system finalizes the transaction after all items have been scanned and verified, either classified as non-age-restricted or successfully verified by a store associate if identified as age-restricted. The system then completes payment and prints a receipt (if needed). Once the transaction is complete, the system is deactivated and reset, waiting for the next customer to initiate a new self-checkout session.

In some embodiments, barcode verification, visual verification, and text recognition may be conducted in parallel, with each process independently assessing the scanned item for age-restriction status. If all processes indicate that the item is not age-restricted, the method 400 proceeds to block 450, where the item list is updated and the transaction proceeds to the next scanned product. However, if any process flags the item as potentially age-restricted, the method 400 moves to block 420, where manual age verification is triggered. The multi-layered verification approach improves the accuracy and reliability of age-restriction verification, as it allows each method to validate the product independently, reducing the risk of oversight if one method alone is inconclusive or compromised. However, this configuration may also increase computational load and power consumption, making it more suitable for systems with sufficient processing capacity. In embodiments where system resources are limited, verification methods may be performed sequentially, or only one or two of the three verification methods may be selected to balance accuracy with efficiency.

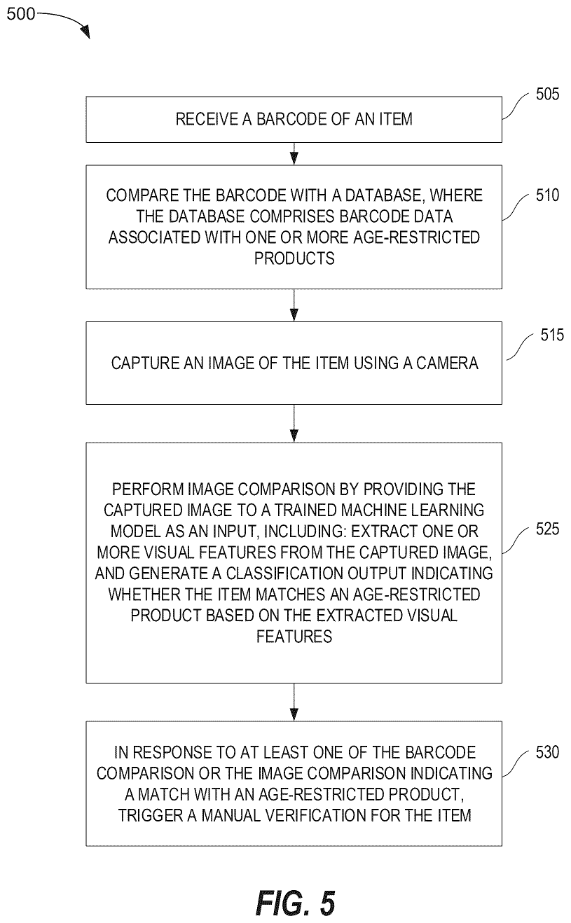

FIG. 5 is a flow diagram illustrating an example method 500 for age-restricted product verification, according to some embodiments of the present disclosure.

At block 505, a self-checkout device receives a barcode of an item.

At block 510, the self-checkout device compares the barcode with a database (e.g., 195 of FIG. 1), where the database comprises barcode data associated with one or more age-restricted products.

At block 515, the self-checkout device captures an image of the item (e.g., 205 of FIG. 2) using a camera (e.g., 145 of FIG. 1).

At block 520, the self-checkout device performs image comparison by providing the captured image to a trained machine learning model as an input, including extracting one or more visual features (e.g., 210-225 of FIG. 2) from the captured image, and generating a classification output (e.g., 245 of FIG. 2) indicating whether the item matches an age-restricted product based on the extracted visual features.

At block 525, in response to at least one of the barcode comparison or the image comparison indicating a match with an age-restricted product, the self-checkout device triggers a manual verification for the item.

In some embodiments, the one or more visual features extracted from the captured image (e.g., 210-225 of FIG. 2) may indicate at least one of shape, size, color, or textual characteristics of the item.

In some embodiments, in response to both the barcode comparison and the image comparison not indicating a match with an age-restricted product, the self-checkout device may perform an additional verification, including: analyzing textual data on the image (e.g., 305 of FIG. 3) to extract one or more terms (e.g., 310 of FIG. 3); and searching a database (e.g., 320 of FIG. 1) using the extracted terms to determine whether the item matches an age-restricted product.

In some embodiments, to trigger the manual verification for the item, the self-checkout device may display a notification on a user interface (UI) (e.g., 105 of FIG. 1) of the self-checkout device to inform a user that the manual verification is needed, and send an alert to a remote device, where the remote device receives the alert to prompt an attendant to assist with the manual verification.

In some embodiments, the barcode may comprise at least one of a universal product code (UPC) or a price look-up (PLU) code for identifying and pricing items.

In some embodiments, the trained machine learning model may comprise convolutional neural networks (CNNs) trained on a training dataset comprising a plurality of images, and where each respective image in the training dataset is associated with a respective classification label, indicating whether a product within the respective image is age-restricted or non-age-restricted.

In some embodiments, the CNNs may be trained on the training dataset, including: using the plurality of images as inputs; using the classification labels as target outputs; and adjusting one or more internal parameters of the CNNs to link one or more visual features extracted from an image to the corresponding classification label, to enable the CNNs to distinguish age-restricted products from non-age-restricted products.

FIG. 6 depicts an example computing device 600 configured to perform various aspects of the present disclosure, according to some embodiments of the present disclosure. In some embodiments, the computing device 600 may be integrated into a self-checkout device (e.g., 100 of FIG. 1) or connected remotely to the self-checkout device via wired links (e.g., Ethernet cable) or wireless links (e.g., Wi-Fi).

As illustrated, the computing device 600 includes a CPU 605, memory 610, storage 615, one or more network interfaces 625, and one or more I/O interfaces 620. In the illustrated aspect, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally considered to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (e.g., keyboards, monitors, camera 145 with built-in processor 150, as depicted in FIG. 1) are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630.

In the illustrated aspect, the memory 610 includes a self-checkout component 650, a barcode verification component 655, an image verification component 660, a text recognition component 665, a reporting component 670, and an image preprocessing component 675.

The self-checkout component 650 may correspond to the module 170 as depicted in FIG. 1. The self-checkout component 650 manages the functions of the self-checkout process, including item scanning, price calculating, payment processing, and transaction finalization. The barcode verification component 655 may correspond to the module 175 as depicted in FIG. 1. The barcode verification component 655 processes barcodes and checks the codes with a database to determine the item's classification. If the barcode matches an age-restricted item, the barcode verification component 655 triggers a prompt for manual age verification. The image verification component 660 may correspond to the module 180 as depicted in FIG. 1. The image verification component 660 analyzes captured images for an item to determine whether the item is age-restricted. CNNs may be used to extract features like shape, size, texture, and color patterns and output probabilities for distinct categories (e.g., the probability that the item is age-restricted and the probability that the item is non-age-restricted). The image verification component 660 triggers manual verification when the model's output indicates a high probability that item is age-restricted (e.g., P₁ (age-restricted) 245-1 of FIG. 2). The text recognition component 665 may correspond to the module 185 as depicted in FIG. 1. The text recognition component 665 extracts and interprets textual information on the item's packaging, and compares the information with a database. The database contains predefined terms linked to known age-restricted items. If a match is found, the component 665 triggers manual verification to check the customer's eligibility. The reporting component 670 may correspond to the module 190 as depicted in FIG. 1. The reporting component 670 logs transaction details and updates the database with each processed item, such as information on verification actions performed and relevant product classification. The reporting component 670 sends alerts to store associates' handheld devices when manual verification is required, and displays notifications to customers on the self-checkout screen. The image preprocessing component 675 may correspond to the module 160 as depicted in FIG. 1. The image preprocessing component 675 adjusts the captured images to improve image clarity, preparing these images for efficient visual verification. The adjustments may include brightness and contrast correction, noise reduction, cropping and resizing, and the like. In some embodiments, the image preprocessing component 675 may be integrated within the self-checkout camera (e.g., 145 of FIG. 1). In such configuration, the camera captures images of scanned items and performs preprocessing operations before providing the optimized images to the main system for further verification.

Although depicted as discrete components for conceptual clarity, in some aspects, the operations of the depicted components (and others not illustrated) may be combined or distributed across any number of components. Further, although depicted as software residing in memory 610, in some aspects, the operations of the depicted components (and others not illustrated) may be implemented using hardware, software, or a combination of hardware and software.

One or more of the described embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the described embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the described embodiments.

Aspects of the described embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a described manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out

Embodiments may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged for the computing resources actually used (e.g. an amount of storage space consumed by a user or a number of virtualized systems instantiated by the user). A user can access any of the resources that reside in the cloud at any time, and from anywhere across the Internet. In context of the described embodiments, a user may access applications (e.g., age-restricted identification) or related data available in the cloud. For example, the age-restricted identification application could execute on a computing system in the cloud and perform product verification. In such a case, the age-restricted identification application could dynamically perform barcode, visual, or textual verifications for scanned items, and store records of transaction data and product classifications in the cloud. Doing so allows a user to access this information from any computing system attached to a network connected to the cloud (e.g., the Internet).

While the foregoing is directed to one or more embodiments, other and further embodiments may be devised without departing from the basic scope thereof, and the scope thereof is determined by the claims that follow.

What is claimed is:

1. A method comprising:
receiving, by a self-checkout device, a barcode of an item;
comparing the barcode with a database, wherein the database comprises barcode data associated with one or more age-restricted products;
capturing an image of the item using a camera;
performing image comparison by providing the captured image to a trained machine learning model as an input, comprising:
extracting one or more visual features from the captured image, and
generating a classification output indicating whether the item matches
an age-restricted product based on the extracted visual features; and
in response to at least one of the barcode comparison or the image comparison indicating a match with an age-restricted product, triggering a manual verification for the item.

2. The method of claim 1, wherein the one or more visual features extracted from the captured image indicate at least one of shape, size, color, or textual characteristics of the item.

3. The method of claim 1, further comprising:
in response to both the barcode comparison and the image comparison not indicating a match with an age-restricted product, performing an additional verification comprising:
analyzing textual data on the image to extract one or more terms; and
searching a database using the extracted terms to determine whether the item matches an age-restricted product.

4. The method of claim 1, wherein the camera is installed to point toward a scanning area of the self-checkout device, and wherein the camera is connected to the self-checkout device via a wired or wireless connection.

5. The method of claim 1, wherein triggering the manual verification for the item comprises:
displaying a notification on a user interface (UI) of the self-checkout device to inform a user that the manual verification is needed; and
sending an alert to a remote device, wherein the remote device receives the alert to prompt an attendant to assist with the manual verification.

6. The method of claim 1, wherein the barcode comprises at least one of a universal product code (UPC) or a price look-up (PLU) code for identifying and pricing items.

7. The method of claim 1, wherein the trained machine learning model comprises convolutional neural networks (CNNs) trained on a training dataset comprising a plurality of images, and wherein each respective image in the training dataset is associated with a respective classification label, indicating whether a product within the respective image is age-restricted or non-age-restricted.

8. The method of claim 7, wherein the CNNs are trained on the training dataset, comprising:
using the plurality of images as inputs;
using the classification labels as target outputs; and
adjusting one or more internal parameters of the CNNs to link one or more visual features extracted from an image to the corresponding classification label, to enable the CNNs to distinguish age-restricted products from non-age-restricted products.

9. A system, comprising:
one or more memories collectively containing one or more programs; and
one or more processors, wherein the one or more processors are configured to, individually or collectively, perform an operation comprising:
receiving, by a self-checkout device, a barcode of an item;
comparing the barcode with a database, wherein the database comprises barcode data associated with one or more age-restricted products;
capturing an image of the item using a camera;
performing image comparison by providing the captured image to a trained machine learning model as an input, comprising:
extracting one or more visual features from the captured image, and
generating a classification output indicating whether the item matches an age-restricted product based on the extracted visual features; and
in response to at least one of the barcode comparison or the image comparison indicating a match with an age-restricted product, triggering a manual verification for the item.

10. The system of claim 9, wherein the one or more visual features extracted from the captured image indicate at least one of shape, size, color, or textual characteristics of the item.

11. The system of claim 9, wherein the operation further comprises:
in response to both the barcode comparison and the image comparison not indicating a match with an age-restricted product, performing an additional verification comprising:
analyzing textual data on the image to extract one or more terms; and
searching a database using the extracted terms to determine whether the item matches an age-restricted product.

12. The system of claim 9, wherein the camera is installed to point toward a scanning area of the self-checkout device, and wherein the camera is connected to the self-checkout device via a wired or wireless connection.

13. The system of claim 9, wherein triggering the manual verification for the item comprises:
displaying a notification on a user interface (UI) of the self-checkout device to inform a user that the manual verification is needed; and
sending an alert to a remote device, wherein the remote device receives the alert to prompt an attendant to assist with the manual verification.

14. The system of claim 9, wherein the barcode comprises at least one of a universal product code (UPC) or a price look-up (PLU) code for identifying and pricing items.

15. The system of claim 9, wherein the trained machine learning model comprises convolutional neural networks (CNNs) trained on a training dataset comprising a plurality of images, and wherein each respective image in the training dataset is associated with a respective classification label, indicating whether a product within the respective image is age-restricted or non-age-restricted.

16. The system of claim 15, wherein the CNNs are trained on the training dataset, comprising:
using the plurality of images as inputs;
using the classification labels as target outputs; and
adjusting one or more internal parameters of the CNNs to link one or more visual features extracted from an image to the corresponding classification label, to enable the CNNs to distinguish age-restricted products from non-age-restricted products.

17. One or more computer-readable media containing, in any combination, computer program code that, when executed by a computer system, performs an operation comprising:
receiving, by a self-checkout device, a barcode of an item;
comparing the barcode with a database, wherein the database comprises barcode data associated with one or more age-restricted products;
capturing an image of the item using a camera;
performing image comparison by providing the captured image to a trained machine learning model as an input, comprising:
extracting one or more visual features from the captured image, and
generating a classification output indicating whether the item matches
an age-restricted product based on the extracted visual features; and
in response to at least one of the barcode comparison or the image comparison indicating a match with an age-restricted product, triggering a manual verification for the item.

18. The one or more computer-readable media of claim 17, wherein the operation further comprising:
in response to both the barcode comparison and the image comparison not indicating a match with an age-restricted product, performing an additional verification comprising:
analyzing textual data on the image to extract one or more terms; and
searching a database using the extracted terms to determine whether the item matches an age-restricted product.

19. The one or more computer-readable media of claim 17, wherein triggering the manual verification for the item comprises:
displaying a notification on a user interface (UI) of the self-checkout device to inform a user that the manual verification is needed; and
sending an alert to a remote device, wherein the remote device receives the alert to prompt an attendant to assist with the manual verification.

20. The one or more computer-readable media of claim 17, wherein the trained machine learning model comprises convolutional neural networks (CNNs) trained on a training dataset comprising a plurality of images, wherein each respective image in the training dataset is associated with a respective classification label, indicating whether a product within the respective image is age-restricted or non-age-restricted.
